(19) United States
(12) Patent Application Publication
(10) Pub. No.: US 2026/0247395 A1
(43) Pub. Date: Aug. 20, 2026

(54) TECHNIQUES FOR USING CHANNEL AWARE CONTROL CHANNEL SEARCH SPACE

(71) Applicant: QUALCOMM Incorporated, San Diego, CA (US)

(72) Inventors: Amit BAR-OR TILLINGER, Tel-Aviv (IL); Shay LANDIS, Hod Hasharon (IL); Ran BERLINER, kfar aviv (IL); Konstantin KUPERSHLAK, Ramat Gan (IL)

(21) Appl. No.: 19/057,420

(22) Filed: Feb. 19, 2025

(51) Int. Cl. H04W 72/231; H04W 72/0453; H04W 72/51; H04W 76/20

(52) U.S. Cl. CPC H04W 72/231; H04W 72/0453; H04W 72/51; H04W 76/20

(57) ABSTRACT

Methods, systems, and devices for wireless communications are described to reduce a quantity of blind decodes performed at a user equipment (UE) when monitoring for downlink control information from a network entity. The quantity of blind decodes at a UE may be reduced through selection of a subset of a set of candidates based on a channel condition associated with two or more candidates of the set of candidates. Channel reciprocity for uplink and downlink channels may provide that the network entity may evaluate the downlink channel response experienced by the UE by measuring the reciprocal uplink channel such that the network entity selects a same candidate, or one of two or more candidates in a subset of candidates. The UE may use downlink channel measurements to select a blind decoding candidate, or subset of candidates, that corresponds to the candidate selected by the network entity.

### FIELD OF TECHNOLOGY

The following relates to wireless communications, including techniques for using channel aware control channel search space.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information that indicates a set of candidates for monitoring for a downlink resource allocation in a downlink control channel transmission, identifying a channel condition associated with two or more portions of a channel between the UE and a network entity, each of the two or more portions of the channel associated with a different candidate of the set of candidates, selecting a subset of candidates from the set of candidates to monitor for the downlink resource allocation based on the channel condition associated with each candidate of the subset of candidates, and monitoring the subset of candidates for the downlink resource allocation.

A UE for wireless communications is described. The UE may include one or more memories storing processor executable code, and one or more processors coupled with the one or more memories. The one or more processors may individually or collectively be operable to execute the code to cause the UE to receive configuration information that indicates a set of candidates for monitoring for a downlink resource allocation in a downlink control channel transmission, identify a channel condition associated with two or more portions of a channel between the UE and a network entity, each of the two or more portions of the channel associated with a different candidate of the set of candidates, select a subset of candidates from the set of candidates to monitor for the downlink resource allocation based on the channel condition associated with each candidate of the subset of candidates, and monitor the subset of candidates for the downlink resource allocation.

Another UE for wireless communications is described. The UE may include means for receiving configuration information that indicates a set of candidates for monitoring for a downlink resource allocation in a downlink control channel transmission, means for identifying a channel condition associated with two or more portions of a channel between the UE and a network entity, each of the two or more portions of the channel associated with a different candidate of the set of candidates, means for selecting a subset of candidates from the set of candidates to monitor for the downlink resource allocation based on the channel condition associated with each candidate of the subset of candidates, and means for monitoring the subset of candidates for the downlink resource allocation.

A non-transitory computer-readable medium storing code for wireless communications is described. The code may include instructions executable by one or more processors to receive configuration information that indicates a set of candidates for monitoring for a downlink resource allocation in a downlink control channel transmission, identify a channel condition associated with two or more portions of a channel between the UE and a network entity, each of the two or more portions of the channel associated with a different candidate of the set of candidates, select a subset of candidates from the set of candidates to monitor for the downlink resource allocation based on the channel condition associated with each candidate of the subset of candidates, and monitor the subset of candidates for the downlink resource allocation.

In some examples of the method, UEs, and non-transitory computer-readable medium described herein, the set of candidates corresponds to a set of UE search space resources that may be configured via radio resource control signaling. Some examples of the method, UEs, and non-transitory computer-readable medium described herein may further include operations, features, means, or instructions for receiving control signaling that indicates a quantity of candidates of the subset of candidates that are to be selected based on the identified channel conditions.

Some examples of the method, UEs, and non-transitory computer-readable medium described herein may further include operations, features, means, or instructions for receiving control signaling that indicates a channel condition threshold for selection of the subset of candidates, where one or more candidates that meet the channel condition threshold are selected for the subset of candidates.

Some examples of the method, UEs, and non-transitory computer-readable medium described herein may further include operations, features, means, or instructions for transmitting an indication of a capability of the UE to select the subset of candidates based on channel conditions.

In some examples of the method, UEs, and non-transitory computer-readable medium described herein, the set of candidates corresponds to all available candidates for monitoring for the downlink resource allocation in the downlink control channel transmission, irrespective of any configured candidates indicated to the UE in control information. Some examples of the method, UEs, and non-transitory computer-readable medium described herein may further include operations, features, means, or instructions for receiving control information that indicates one or more of, a quantity of candidates of the subset of candidates that are to be selected, a difference threshold for measured channel conditions relative to a most favorable measured channel condition, where a candidate that has a measured channel condition within the difference threshold is selected for inclusion in the subset of candidates, and one or more aggregation levels that are to be monitored for the subset of candidates. In some examples of the method, UEs, and non-transitory computer-readable medium described herein, the subset of candidates correspond to frequency domain resources with a highest channel capacity based on one or more reference signal measurements associated with the set of candidates.

In some examples of the method, UEs, and non-transitory computer-readable medium described herein, the set of candidates corresponds to a set of configured candidates indicated to the UE in control information, and each candidate of the subset of candidates is selected from the set of configured candidates based on a corresponding channel condition that meets a selection criteria. Some examples of the method, UEs, and non-transitory computer-readable medium described herein may further include operations, features, means, or instructions for receiving control information that indicates one or more of a quantity of candidates per aggregation level to be included in the subset of candidates, or one or more aggregation levels to be monitored for each candidate of the subset of candidates. In some examples of the method, UEs, and non-transitory computer-readable medium described herein, the subset of candidates may be selected based on an averaged channel capacity per candidate over all candidate resources of the set of candidates for each aggregation level of two or more available aggregation levels.

In some examples of the method, UEs, and non-transitory computer-readable medium described herein, the set of candidates corresponds to a set of configured candidates indicated to the UE in control information, and each candidate of the subset of candidates is selected from the set of configured candidates based on an estimated channel capacity associated with each candidate of the set of candidates, where the estimated channel capacity is based on an associated channel condition. In some examples of the method, UEs, and non-transitory computer-readable medium described herein, a frequency domain location of each candidate of the subset of candidates is selected based on an averaged channel capacity per candidate for a frequency offset from a frequency indicated for the set of configured candidates for each aggregation level associated with the set of configured candidates, and where the frequency offset is selected such that each candidate of the subset of candidates remains within a set of frequency resources of the set of configured candidates.

A method for wireless communications by a network entity is described. The method may include outputting, to a UE, configuration information that indicates a set of candidates for monitoring at the UE for a downlink resource allocation in a downlink control channel transmission, and an indication that the UE is to select a subset of candidates from the set of candidates to monitor for the downlink resource allocation based on a channel condition of a portion of a channel between the UE and the network entity associated with each candidate of the subset of candidates, identifying the channel condition associated with two or more portions of the channel between the UE and the network entity, each of the two or more portions of the channel associated with a different candidate of the set of candidates, selecting, based on the identified channel conditions, a first candidate of the subset of candidates for transmission of first control information that indicates the downlink resource allocation, and outputting the first control information for transmission to the UE.

A network entity for wireless communications is described. The network entity may include one or more memories storing processor executable code, and one or more processors coupled with the one or more memories. The one or more processors may individually or collectively be operable to execute the code to cause the network entity to output, to a UE, configuration information that indicates a set of candidates for monitoring at the UE for a downlink resource allocation in a downlink control channel transmission, and an indication that the UE is to select a subset of candidates from the set of candidates to monitor for the downlink resource allocation based on a channel condition of a portion of a channel between the UE and the network entity associated with each candidate of the subset of candidates, identify the channel condition associated with two or more portions of the channel between the UE and the network entity, each of the two or more portions of the channel associated with a different candidate of the set of candidates, select, based on the identified channel conditions, a first candidate of the subset of candidates for transmission of first control information that indicates the downlink resource allocation, and output the first control information for transmission to the UE.

Another network entity for wireless communications is described. The network entity may include means for outputting, to a UE, configuration information that indicates a set of candidates for monitoring at the UE for a downlink resource allocation in a downlink control channel transmission, and an indication that the UE is to select a subset of candidates from the set of candidates to monitor for the downlink resource allocation based on a channel condition of a portion of a channel between the UE and the network entity associated with each candidate of the subset of candidates, means for identifying the channel condition associated with two or more portions of the channel between the UE and the network entity, each of the two or more portions of the channel associated with a different candidate of the set of candidates, means for selecting, based on the identified channel conditions, a first candidate of the subset of candidates for transmission of first control information that indicates the downlink resource allocation, and means for outputting the first control information for transmission to the UE.

A non-transitory computer-readable medium storing code for wireless communications is described. The code may include instructions executable by one or more processors to output, to a UE, configuration information that indicates a set of candidates for monitoring at the UE for a downlink resource allocation in a downlink control channel transmission, and an indication that the UE is to select a subset of candidates from the set of candidates to monitor for the downlink resource allocation based on a channel condition of a portion of a channel between the UE and the network entity associated with each candidate of the subset of candidates, identify the channel condition associated with two or more portions of the channel between the UE and the network entity, each of the two or more portions of the channel associated with a different candidate of the set of candidates, select, based on the identified channel conditions, a first candidate of the subset of candidates for transmission of first control information that indicates the downlink resource allocation, and output the first control information for transmission to the UE.

In some examples of the method, network entities, and non-transitory computer-readable medium described herein, the set of candidates corresponds to a set of UE search space resources that may be configured via radio resource control signaling. Some examples of the method, network entities, and non-transitory computer-readable medium described herein may further include operations, features, means, or instructions for outputting control signaling that indicates a quantity of candidates of the subset of candidates that are to be selected at the UE based on the identified channel conditions.

Some examples of the method, network entities, and non-transitory computer-readable medium described herein may further include operations, features, means, or instructions for outputting control signaling that indicates a channel condition threshold for selection of the subset of candidates at the UE, where one or more candidates that meet the channel condition threshold are selected at the UE for the subset of candidates.

Some examples of the method, network entities, and non-transitory computer-readable medium described herein may further include operations, features, means, or instructions for obtaining an indication of a capability of the UE to select the subset of candidates based on channel conditions.

In some examples of the method, network entities, and non-transitory computer-readable medium described herein, the set of candidates corresponds to all available candidates for monitoring for the downlink resource allocation in the downlink control channel transmission, irrespective of any configured candidates indicated to the UE in control information. Some examples of the method, network entities, and non-transitory computer-readable medium described herein may further include operations, features, means, or instructions for outputting control information that indicates one or more of, a quantity of candidates of the subset of candidates that are to be selected, a difference threshold for measured channel conditions relative to a most favorable measured channel condition, where a candidate that has a measured channel condition within the difference threshold is to be selected for inclusion in the subset of candidates, and one or more aggregation levels that are to be monitored for the subset of candidates. In some examples of the method, network entities, and non-transitory computer-readable medium described herein, the first candidate may be selected in accordance with an estimated highest channel capacity of the set of candidates based on one or more reference signal measurements associated with the set of candidates.

In some examples of the method, network entities, and non-transitory computer-readable medium described herein, the set of candidates corresponds to a set of configured candidates indicated to the UE in control information, and the configuration information indicates that each candidate of the subset of candidates is to be selected at the UE from the set of configured candidates based on a corresponding channel condition that meets a selection criteria. Some examples of the method, network entities, and non-transitory computer-readable medium described herein may further include operations, features, means, or instructions for outputting control information that indicates one or more of a quantity of candidates per aggregation level to be included in the subset of candidates, or one or more aggregation levels to be monitored for each candidate of the subset of candidates. In some examples of the method, network entities, and non-transitory computer-readable medium described herein, the first candidate may be selected based on an averaged channel capacity per candidate over all candidate resources of the set of candidates for each aggregation level of two or more available aggregation levels.

In some examples of the method, network entities, and non-transitory computer-readable medium described herein, the set of candidates corresponds to a set of configured candidates indicated to the UE in control information, and the configuration information indicates that the UE is to select each candidate of the subset of candidates from the set of configured candidates based on an estimated channel capacity associated with each candidate of the set of candidates. In some examples of the method, network entities, and non-transitory computer-readable medium described herein, a frequency domain location of the first candidate is selected based on an averaged channel capacity per candidate for a frequency offset from a frequency indicated for the set of configured candidates for each aggregation level associated with the set of configured candidates, and where the frequency offset is selected such that the first candidate remains within a set of frequency resources of the set of configured candidates.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for using channel aware control channel search space in accordance with one or more aspects of the present disclosure.

FIG. 2 shows an example of a wireless communications system that supports techniques for using channel aware control channel search space in accordance with one or more aspects of the present disclosure.

FIG. 3 shows an example graph of a measured channel response that supports techniques for using channel aware control channel search space in accordance with one or more aspects of the present disclosure.

FIG. 4 shows an example of a process flow that supports techniques for using channel aware control channel search space in accordance with one or more aspects of the present disclosure.

FIGS. 5 and 6 show block diagrams of devices that support techniques for using channel aware control channel search space in accordance with one or more aspects of the present disclosure.

FIG. 7 shows a block diagram of a communications manager that supports techniques for using channel aware control channel search space in accordance with one or more aspects of the present disclosure.

FIG. 8 shows a diagram of a system including a device that supports techniques for using channel aware control channel search space in accordance with one or more aspects of the present disclosure.

FIGS. 9 and 10 show block diagrams of devices that support techniques for using channel aware control channel search space in accordance with one or more aspects of the present disclosure.

FIG. 11 shows a block diagram of a communications manager that supports techniques for using channel aware control channel search space in accordance with one or more aspects of the present disclosure.

FIG. 12 shows a diagram of a system including a device that supports techniques for using channel aware control channel search space in accordance with one or more aspects of the present disclosure.

FIGS. 13 and 14 show flowcharts illustrating methods that support techniques for using channel aware control channel search space in accordance with one or more aspects of the present disclosure.

### DETAILED DESCRIPTION

Some wireless communications systems may provide downlink control information (DCI) to a user equipment (UE) in a downlink control channel (e.g., a physical downlink control channel (PDCCH)). In some systems, a UE may monitor for DCI by performing blind decoding of multiple candidate locations in which DCI may be present, and identifying the DCI based on a determination that the DCI is associated with an identifier of the UE (e.g., a radio network temporary identifier (RNTI)). For example, the DCI may be scrambled using an identifier associated with the UE. In some cases, a UE may be configured with a search space that indicates one or more areas in a downlink resource grid where a downlink control channel may be carried, and the UE may perform blind decoding throughout the search space to identify control channel data (e.g., DCI) intended for the UE. Particular areas in the downlink resource grid that are monitored for a control channel transmission at a UE may be referred to as candidate locations, blind decoding candidates, a set of candidates, or simply candidates, where the UE may perform blind decoding.

Such blind decoding techniques may consume a relatively large amount of power at a UE. For example, the power consumption associated with PDCCH monitoring may correspond to a quantity of blind decoding attempts the UE performs for a configured search space. Each of the decoding attempts may consume a relatively large amount of computational processing resources to execute the relevant reception flow (e.g., channel estimation, equalization, and Polar decoding). Further, each decoding attempt may increase the overall latency of the PDCCH processing, and higher latency of the PDCCH processing translates to a longer ON time of the radio frequency (RF) and the digital front end (DFE) chains in the case no DCI was detected, which also contribute to the power consumption.

In accordance with various aspects discussed herein, a quantity of blind decoding operations at a UE may be reduced through selection of a subset of a set of DCI candidate locations in a search space. In some aspects, a network entity that transmits DCI, and a UE, may select the subset of candidate locations based on a channel condition associated with candidate locations of the set of candidate locations. In some aspects, channel reciprocity for uplink and downlink channels (e.g., in accordance with time division duplexing (TDD) communications between the network entity and the UE) may provide that the network entity may evaluate the downlink channel response experienced by UE by measuring the reciprocal uplink channel using one or more uplink reference signals (e.g., sounding reference signal (SRS) or demodulation reference signal (DMRS) transmissions of the UE). Additionally, or alternatively, the network entity may obtain downlink channel knowledge based on UE feedback (e.g., that indicates channel conditions at the UE across a set of frequency resources). In some aspects, the network entity may dynamically select a candidate location for PDCCH resource (e.g., a number of control channel elements (CCEs)) that provides enhanced channel capacity in accordance with its knowledge of the downlink channel response, assuming channel reciprocity or using UE feedback. Further, the UE also may identify the same resources, without additional signaling from the network entity, based on the downlink channel response. In some aspects, a pool of resources that may be used for control channel transmission may be limited to UE search space resources (e.g., as configured by radio resource control (RRC) signaling). Additionally, or alternatively, the network entity may configure the UE with a quantity of best candidates to be monitored (e.g., via RRC signaling), or may configure the UE with a threshold value for a power gap from a best measured resource to be considered as candidate (e.g., search space candidates with associated channel conditions within the threshold value from a search space candidate with a best channel condition are included in the subset of candidates).

Techniques as discussed herein may provide a number of benefits and advantages. For example, selection of control channel resources based on channel conditions may provide resources that enhance channel capacity, and therefore reduce the number of resources to be processed (e.g., an aggregation level of a DCI transmission). Further, reduction in the number of candidates to be monitored may provide power savings and latency reduction by providing one, or a relatively small amount, of candidates that are blind decoded at the UE. Additionally, techniques as discussed herein provide for selection of a subset of one or more candidate locations from a set of candidate locations without using additional control overhead, because both the UE and the network entity (assuming channel reciprocity) use the same channel conditions to select the subset of candidate location(s).

Aspects of the disclosure are initially described in the context of wireless communications systems. Aspects of the disclosure are further illustrated by and described with reference to an exemplary measured channel response, process flow, apparatus diagrams, system diagrams, and flowcharts that relate to techniques for using channel aware control channel search space.

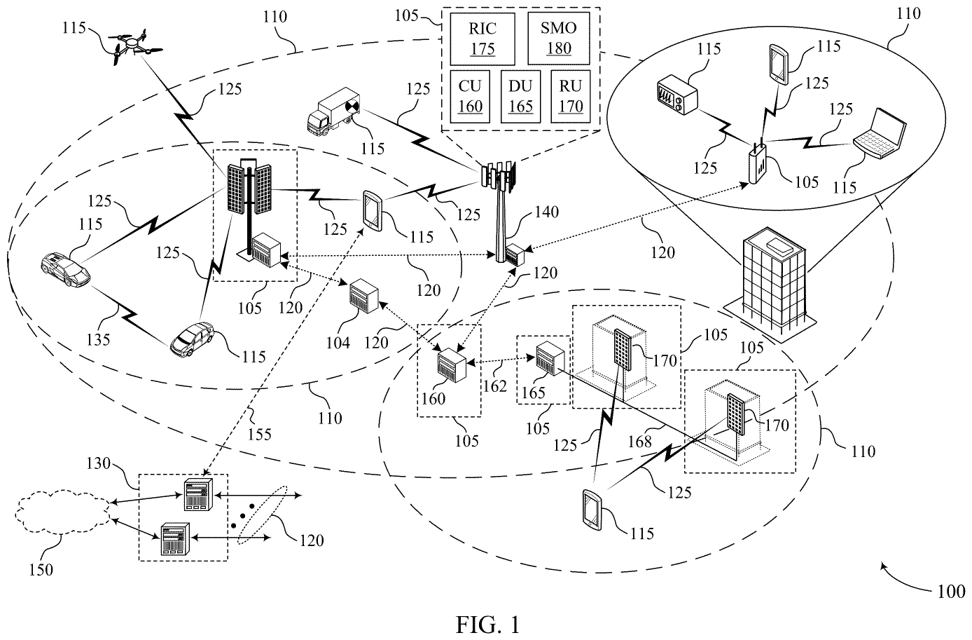

FIG. 1 shows an example of a wireless communications system 100 that supports techniques for using channel aware control channel search space in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for using channel aware control channel search space as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As discussed herein, a UE 115 may perform blind decoding on a set of candidates to detect DCI that may be transmitted by a network entity 105. In some aspects, a quantity of blind decoding operations at a UE 115 may be reduced through selection of a subset of the set of candidates. In some aspects, a network entity 105 that transmits DCI, and a UE 115 that performs blind decoding to detect DCI, both may select the subset of candidates based on a channel condition associated with two or more candidate locations of the set of candidates. In some aspects, channel reciprocity for uplink and downlink channels may provide that the network entity 105 may evaluate the downlink channel response experienced by UE 115 by measuring the reciprocal uplink channel using one or more uplink reference signals (e.g., SRS or DMRS transmissions of the UE 115). Additionally, or alternatively, the network entity 105 may obtain downlink channel knowledge based on UE 115 feedback (e.g., a measurement report or other feedback that indicates channel conditions at the UE 115 across a set of frequency resources).

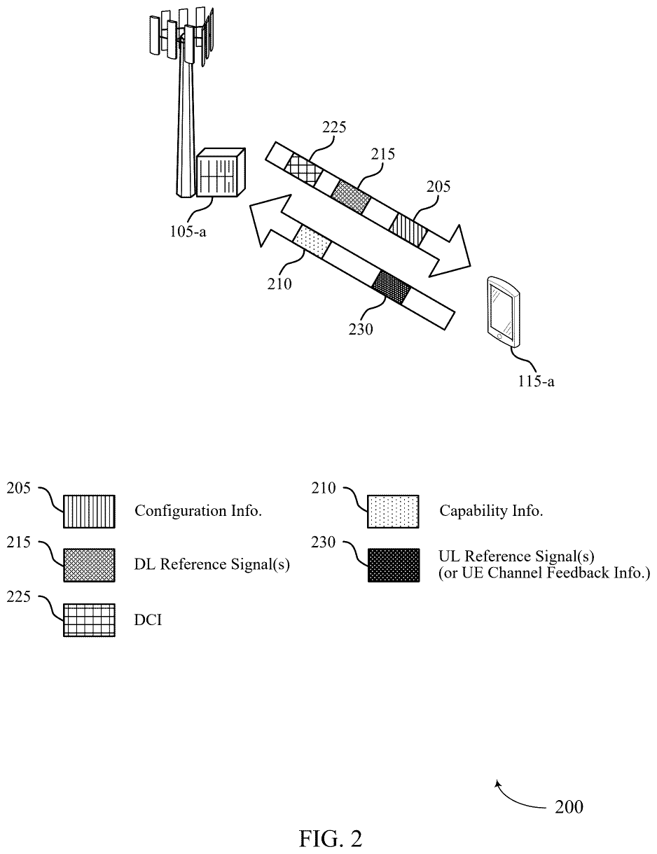

FIG. 2 shows an example of a wireless communications system 200 that supports techniques for using channel aware control channel search space in accordance with one or more aspects of the present disclosure. In some cases, the wireless communications system 200 may implement or be implemented by aspects of the wireless communications system 100. For example, the wireless communications system 200 may include one or more UEs 115 and one or more network entities 105, including UE 115-a and network entity 105-a, which may be examples of the corresponding devices as described herein.

In some aspects, the UE 115-a may perform blind decoding on multiple candidate locations to determine if one of the candidate locations contains control channel information (e.g., DCI 225 transmitted via PDCCH) for the UE 115-a. In accordance with various aspects discussed herein, a quantity of blind decoding operations at the UE 115-a may be reduced through selection of a subset of a set of DCI candidates in a search space. In some aspects, the network entity 105-a may transmit DCI, and the UE 115-a may monitor for DCI in accordance with a search space that is indicated in configuration information 205. In some aspects, the configuration information may include an indication of a set of candidate locations that may be used to identify resources over which blind decoding is to be performed to determine if DCI for the UE 115-a is present. In some aspects, the network entity 105-a may transmit an indication to the UE 115-a (e.g., with configuration information 205, or in a separate downlink transmission such as control information provided via DCI or a MAC control element (MAC-CE)) that indicates the UE 115-a is to select a subset of the set of candidate locations based on channel conditions of respective candidate locations. The UE 115-a may measure one or more downlink reference signals 215 and determine channel conditions of the downlink channel. The subset of candidate locations may be selected in accordance with the control information and the measured channel conditions.

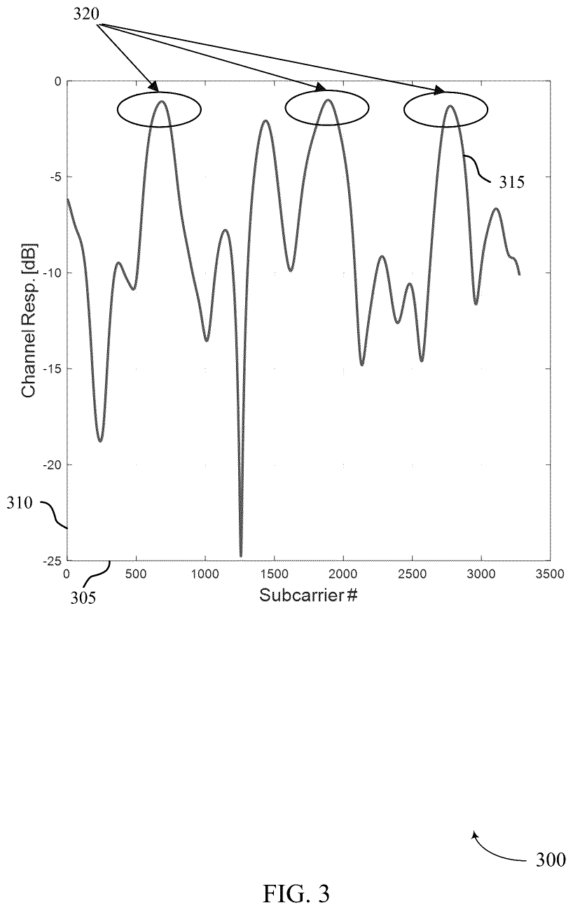

In some aspects, channel reciprocity for uplink and downlink channels (e.g., in accordance with TDD communications between the network entity 105-a and the UE 115-a) may provide that the network entity 105-a may evaluate the downlink channel response experienced by UE 115-a by measuring the reciprocal uplink channel using one or more uplink reference signals 230 (e.g., SRS or DMRS transmissions of the UE 115-a). Additionally, or alternatively, the network entity 105-a may obtain downlink channel knowledge based on UE 115-a feedback (e.g., provided via uplink control information (UCI) or a MAC-CE) that indicates channel conditions at the UE 115-a. In some aspects, the network entity 105-a may dynamically select a location for DCI 225 as a PDCCH resource (e.g., a number of CCEs) that provides enhanced channel capacity in accordance with its knowledge of the downlink channel response. Further, the UE 115-a also may identify the same resources, without additional signaling from the network entity 105-a, based on the downlink channel response. FIG. 3 shows an example of a measured downlink channel response in accordance with various aspects. In some aspects, the UE 115-a may transmit capability information 210 that indicates a capability of the UE 115-a for selection of candidate locations based on downlink channel conditions, and the network entity 105-a may transmit the configuration information 205 in accordance with the capabilities of the UE 115-a.

FIG. 3 shows an example graph 300 of a measured channel response that supports techniques for using channel aware control channel search space in accordance with one or more aspects of the present disclosure. In some cases, graph 300 of the measured channel response may implement or be implemented by aspects of the wireless communications system 100 or 200. For example, the graph 300 of the measured channel response may be used to select a subset of candidate locations from a set of configured candidate locations of a PDCCH search space that is configured at a UE.

In the example of FIG. 3, a UE may measure a downlink reference signal (e.g., a channel state information (CSI) reference signal) across a set of subcarriers 305, such as subcarriers of a configured bandwidth part (BWP) of the UE. The channel response 310 may be identified (e.g., a reference signal received power (RSRP) measured in dB) across the set of subcarriers 305 based on measurements of the reference signal, which is illustrated as curve 315 in FIG. 3. In this example, the curve 315 shows three peaks 320 associated with a highest power of the channel response.

In some aspects, the UE and the network entity may use the channel response 310 associated with different subcarriers to select a center of a PDCCH allocation for a DCI transmission to the UE (e.g., the subcarrier with the highest channel response 310 may be selected to be the center of the PDCCH allocation). In such examples, the subset of candidate locations may not be limited to the configured candidates associated with the configured search space, and may only be based on the channel conditions. In such aspects, the UE may signal a channel aware PDCCH search space capability, and the network entity may signal (e.g., in control information provided with configuration information via RRC, or provided in a different downlink communication such as DCI or a MAC-CE) a quantity (e.g., 3) of best candidates that are to be selected for the subset of candidate locations (e.g., corresponding to the three peaks 320 of FIG. 3). Additionally, or alternatively, the network entity may signal an allowed gap or threshold from a peak channel response measurement (e.g., within 3 dB of a highest power channel response 310 value). Further, the network entity may signal the aggregation levels to be monitored at the UE.

In operation, based on the configuration provided by the network entity, the network entity and UE may identify the frequency domain resources with highest channel capacity (e.g., based on subcarriers with the highest channel response 310 values). As discussed herein, the network entity may identify such a resource based on one or more uplink reference signals (e.g., DMRS or SRS), or based on feedback from the UE (e.g., a measurement report provided by the UE). Further, the UE may identify the frequency domain resources with highest channel capacity. In some cases, several local maximum resources may be identified (e.g., the UE may select a subset of candidates), based on the configuration information provided by the network entity. The network entity may select one of the local maximum as the center of PDCCH allocation, and transmit the PDCCH in accordance with the selected resource. The UE may monitor each of the several local minimums for PDCCH allocation based on the specified aggregation levels to be monitored.

In other aspects, the subset of candidate locations may be selected from the configured candidates associated with the configured search space of the UE. In such aspects, a control resource set (CORESET) resource grid may be maintained, and one or more best candidates, based on channel capacity, may be monitored at the UE. In such aspects, the UE may signal a channel aware PDCCH search space capability, and the network entity may signal a quantity of best candidates per aggregation level that are to be monitored (e.g., which may be referred to as K(L)), and may signal the aggregation levels to be monitored. In operation, for each aggregation level (over all configured CORESETs), the network entity and UE may evaluate the averaged channel capacity per candidate over all the candidate resources. For example, the network entity may perform such an evaluation based on uplink reference signals (e.g., DMRS or SRS) or based on a UE measurement report (e.g., a CSI report). The UE may perform such an evaluation based on one or more downlink reference signals (e.g., downlink DMRS or CSI-RS). The network entity may select one of the of the top K(L) candidates for PDDCH allocation, and the UE monitors each of the K(L) candidates for PDCCH allocation in accordance with blind decoding techniques.

In further aspects, a starting resource block (RB) of a candidate location may be identified based on channel response 310 values. In such aspects, the CORESET grid may be maintained, however, a candidate starting RB may be selected such that the channel capacity is enhanced. In operation, such aspects may include a UE indication of a channel aware PDCCH search space capability, and the network entity may signal a quantity of best candidate(s) per aggregation level that are to be monitored (e.g., K(L)). The network entity also may signal the aggregation levels to be monitored. For each aggregation level (over all configured CORESETs), the network entity and UE may evaluate the averaged channel capacity per candidate assuming an additional offset of ‘q’ RBs in the frequency domain, such that the candidate resources remain within the CORESET resources. Similarly as discussed above, the network entity may perform such an evaluation based on uplink reference signals (e.g., DMRS or SRS) or based on a UE measurement report (e.g., a CSI report). The UE may perform such an evaluation based on one or more downlink reference signals (e.g., downlink DMRS or CSI-RS). The network entity may select one of the of the top K(L) candidates for PDDCH allocation with the appropriate offset q* RBs, and the UE may monitor each of the K(L) candidates for PDCCH allocation with the appropriate offset q* RBs.

In some aspects, techniques as discussed herein may provide enhanced channel capacity for PDCCH transmissions, which may enhance overall network efficiency and reliability, while also reducing UE power consumption. For example, a signal to noise ratio (SNR) difference between a candidate location with the average versus best channel condition may be about 6 dB, and a SNR difference between the poorest and best channel condition may be about 25 dB. Moreover, as the UE channel conditions are degraded, the amount of PDCCH resources is increased (e.g., using higher aggregation levels), and therefore most PDCCH resources may be allocated for UEs with the poorest channel conditions (e.g., worst case SNR may be assumed). In addition, for low SNRs (e.g., below 0 [dB]) the channel capacity is approximately linear with the SNR, as:

$$C = B * {log}_{2} ( 1 + SNR ) \to B * SNR * {log}_{2} ( e ) .$$

This means the SNR improvement in a factor ‘m’ can be translated to bandwidth reduction by the same factor.

Therefore, techniques for channel aware PDCCH may reduce most of the allocations at factors above 4 (and up to hundreds). This reduction in bandwidth can be translated to reduction in the number of candidates to be monitored, K(L). This improvement may be kept in high interferences scenarios. Thus, PDCCH blocking probability may be reduced. Further, since candidate selection is based on the channel response, without considering any interferences, the described techniques may be resilient to differences of the interferences between the network entity and UE. In some aspects, however, the network entity may apply an appropriate backoff to mitigate any unknown interference at the UE. In some aspects, channel aware PDCCH search space selection may be advantageously implemented for UEs with low SNRs and low mobility conditions, and may be enabled or disabled in a semi-static manner in accordance with conditions at the UE.

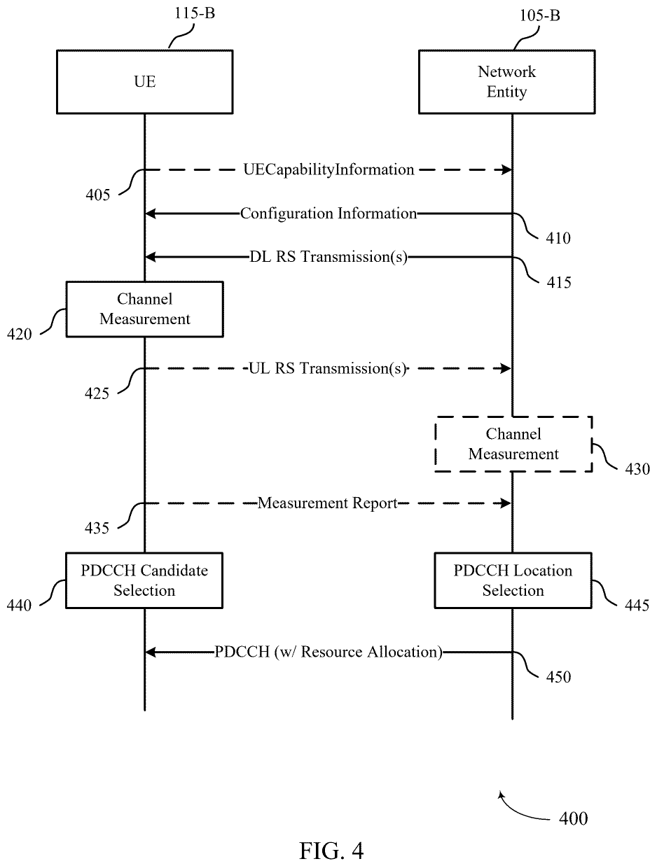

FIG. 4 shows an example of a process flow 400 that supports techniques for using channel aware control channel search space in accordance with one or more aspects of the present disclosure. In some cases, the process flow 400 may implement or be implemented by aspects of the wireless communications system 100, the wireless communications system 200, the graph 300, or any combination thereof. For example, the process flow 400 may include a UE 115-b and network entity 105-b, which may be examples of the corresponding devices as described herein. In the following description of the process flow 400, the operations between the UE 115-b and network entity 105-b, may be transmitted in a different order than the example order shown, or may be performed in different orders or at different times. Some operations may also be omitted from the process flow 400, and other operations may be added to the process flow 400.

At 405, in some cases, the UE 115-b may transmit, and the network entity 105-b may receive, UE capability information. The capability information may indicate a capability for channel aware PDCCH candidate selection from a set of candidate locations, in accordance with various aspects as discussed herein. The capability information may be transmitted in RRC signaling, for example.

At 410, the network entity 105-b may transmit, and the UE 115-b may receive, configuration information. The configuration information may indicate a set of candidate locations for PDCCH transmissions, where the UE 115-b may perform blind decoding across the set of candidate locations for an associated PDCCH (e.g., a DCI transmission). In some aspects, the configuration information may indicate that a subset of candidate locations is to be selected for PDCCH transmissions, in accordance with various aspects discussed herein.

At 415, the network entity 105-b may transmit, and the UE 115-b may receive, one or more downlink reference signals (e.g., CSI-RS, DMRS). At 420, the UE 115-b may measure the one or more downlink reference signals and determine a channel response associated with the downlink channel. In some cases, at 425, the UE 115-b may transmit, and the network entity 105-b may receive, one or more uplink reference signals (e.g., SRS, DMRS). At 430, the network entity 105-b may measure the one or more uplink reference signals and determine a channel response associated with the downlink channel, based on channel reciprocity. Alternatively, at 435, the UE 115-b may transmit, and the network entity 105-b may receive, a measurement report that indicates the downlink channel response.

At 440, the UE 115-b may select a subset of PDCCH candidate locations for blind decoding in accordance with the measured downlink reference signals and the configuration for channel aware PDCCH locations. Such selection may be performed in accordance with techniques discussed herein. At 445, the network entity 105-b may select a PDCCH location in accordance with the downlink channel response and the configuration for channel aware PDCCH locations. Such selection may be performed in accordance with techniques discussed herein. At 450, the network entity 105-b may transmit, and the UE 115-b may receive, a PDCCH (e.g., with a downlink resource allocation for the UE 115-b). The UE 115-b may receive the PDCCH by bling decoding the subset of candidate locations, in accordance with techniques discussed herein.

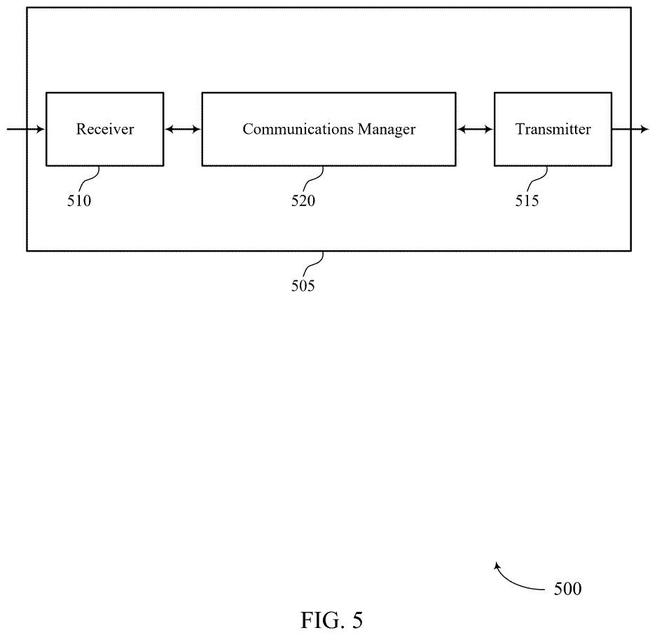

FIG. 5 shows a block diagram 500 of a device 505 that supports techniques for using channel aware control channel search space in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for using channel aware control channel search space). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for using channel aware control channel search space). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for using channel aware control channel search space as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving configuration information that indicates a set of candidates for monitoring for a downlink resource allocation in a downlink control channel transmission. The communications manager 520 is capable of, configured to, or operable to support a means for identifying a channel condition associated with two or more portions of a channel between the UE and a network entity, each of the two or more portions of the channel associated with a different candidate of the set of candidates. The communications manager 520 is capable of, configured to, or operable to support a means for selecting a subset of candidates from the set of candidates to monitor for the downlink resource allocation based on the channel condition associated with each candidate of the subset of candidates. The communications manager 520 is capable of, configured to, or operable to support a means for monitoring the subset of candidates for the downlink resource allocation.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for selection of control channel resources for monitoring for DCI based on channel conditions, which may enhance channel capacity, reduce a quantity of resources to be processed, reduce power consumption, reduce latency, or any combinations thereof.

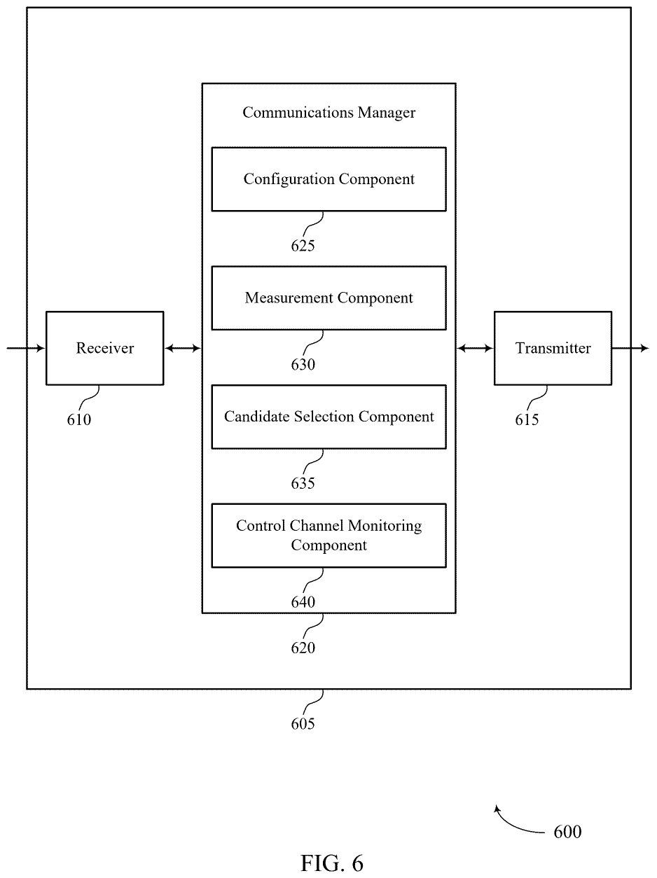

FIG. 6 shows a block diagram 600 of a device 605 that supports techniques for using channel aware control channel search space in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for using channel aware control channel search space). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for using channel aware control channel search space). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for using channel aware control channel search space as described herein. For example, the communications manager 620 may include a configuration component 625, a measurement component 630, a candidate selection component 635, a control channel monitoring component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration component 625 is capable of, configured to, or operable to support a means for receiving configuration information that indicates a set of candidates for monitoring for a downlink resource allocation in a downlink control channel transmission. The measurement component 630 is capable of, configured to, or operable to support a means for identifying a channel condition associated with two or more portions of a channel between the UE and a network entity, each of the two or more portions of the channel associated with a different candidate of the set of candidates. The candidate selection component 635 is capable of, configured to, or operable to support a means for selecting a subset of candidates from the set of candidates to monitor for the downlink resource allocation based on the channel condition associated with each candidate of the subset of candidates. The control channel monitoring component 640 is capable of, configured to, or operable to support a means for monitoring the subset of candidates for the downlink resource allocation.

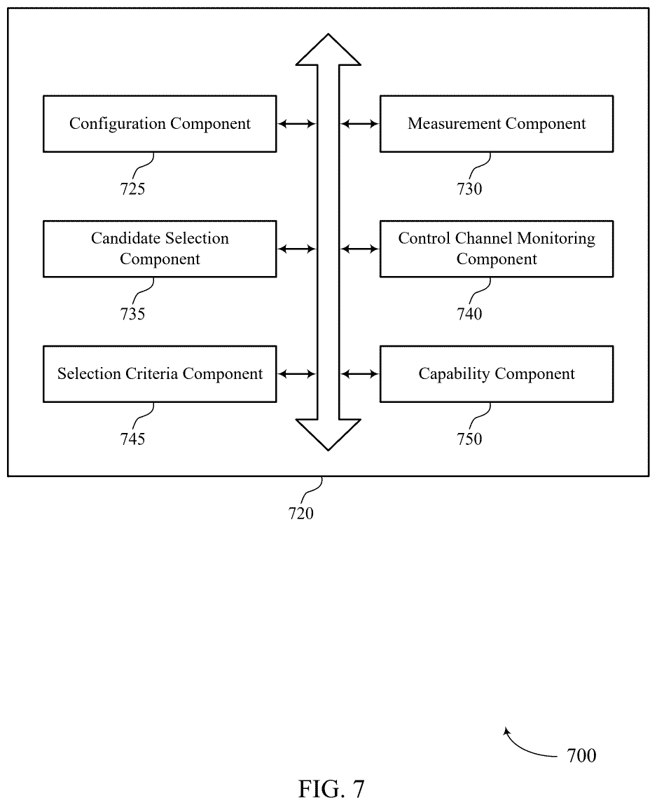

FIG. 7 shows a block diagram 700 of a communications manager 720 that supports techniques for using channel aware control channel search space in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for using channel aware control channel search space as described herein. For example, the communications manager 720 may include a configuration component 725, a measurement component 730, a candidate selection component 735, a control channel monitoring component 740, a selection criteria component 745, a capability component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration component 725 is capable of, configured to, or operable to support a means for receiving configuration information that indicates a set of candidates for monitoring for a downlink resource allocation in a downlink control channel transmission. The measurement component 730 is capable of, configured to, or operable to support a means for identifying a channel condition associated with two or more portions of a channel between the UE and a network entity, each of the two or more portions of the channel associated with a different candidate of the set of candidates. The candidate selection component 735 is capable of, configured to, or operable to support a means for selecting a subset of candidates from the set of candidates to monitor for the downlink resource allocation based on the channel condition associated with each candidate of the subset of candidates. The control channel monitoring component 740 is capable of, configured to, or operable to support a means for monitoring the subset of candidates for the downlink resource allocation.

In some examples, the set of candidates corresponds to a set of UE search space resources that are configured via radio resource control signaling. In some examples, the selection criteria component 745 is capable of, configured to, or operable to support a means for receiving control signaling that indicates a quantity of candidates of the subset of candidates that are to be selected based on the identified channel conditions. In some examples, the selection criteria component 745 is capable of, configured to, or operable to support a means for receiving control signaling that indicates a channel condition threshold for selection of the subset of candidates, where one or more candidates that meet the channel condition threshold are selected for the subset of candidates. In some examples, the capability component 750 is capable of, configured to, or operable to support a means for transmitting an indication of a capability of the UE to select the subset of candidates based on channel conditions.

In some examples, the set of candidates corresponds to all available candidates for monitoring for the downlink resource allocation in the downlink control channel transmission, irrespective of any configured candidates indicated to the UE in control information. In some examples, the selection criteria component 745 is capable of, configured to, or operable to support a means for receiving control information that indicates one or more of: a quantity of candidates of the subset of candidates that are to be selected; a difference threshold for measured channel conditions relative to a most favorable measured channel condition, where a candidate that has a measured channel condition within the difference threshold is selected for inclusion in the subset of candidates; or one or more aggregation levels that are to be monitored for the subset of candidates. In some examples, the subset of candidates correspond to frequency domain resources with a highest channel capacity based on one or more reference signal measurements associated with the set of candidates.

In some examples, the set of candidates corresponds to a set of configured candidates indicated to the UE in control information, and each candidate of the subset of candidates is selected from the set of configured candidates based on a corresponding channel condition that meets a selection criteria. In some examples, the selection criteria component 745 is capable of, configured to, or operable to support a means for receiving control information that indicates one or more of a quantity of candidates per aggregation level to be included in the subset of candidates, or one or more aggregation levels to be monitored for each candidate of the subset of candidates. In some examples, the subset of candidates are selected based on an averaged channel capacity per candidate over all candidate resources of the set of candidates for each aggregation level of two or more available aggregation levels.

In some examples, the set of candidates corresponds to a set of configured candidates indicated to the UE in control information, and each candidate of the subset of candidates is selected from the set of configured candidates based on an estimated channel capacity associated with each candidate of the set of candidates, where the estimated channel capacity is based on an associated channel condition. In some examples, a frequency domain location of each candidate of the subset of candidates is selected based on an averaged channel capacity per candidate for a frequency offset from a frequency indicated for the set of configured candidates for each aggregation level associated with the set of configured candidates, and where the frequency offset is selected such that each candidate of the subset of candidates remains within a set of frequency resources of the set of configured candidates.

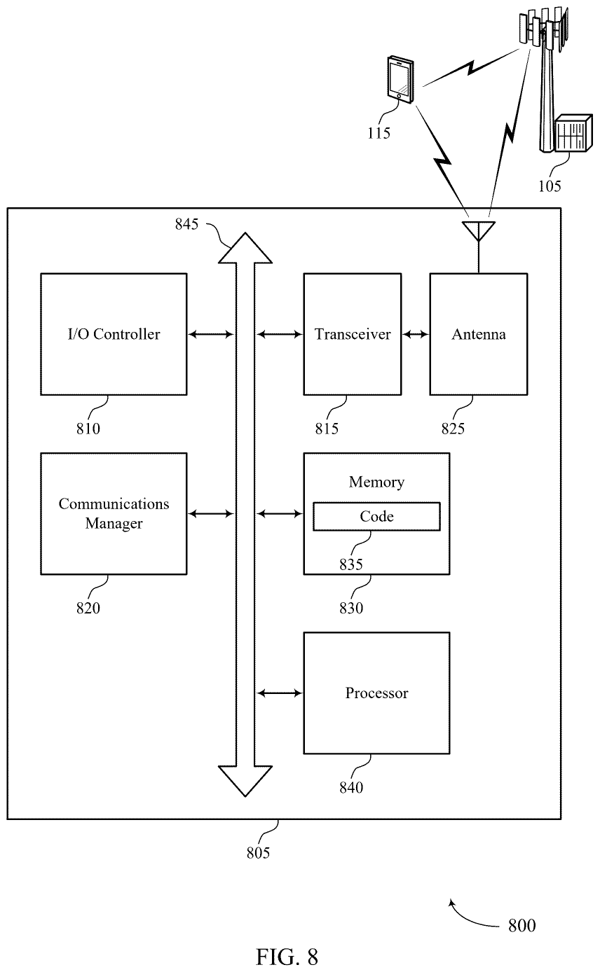

FIG. 8 shows a diagram of a system 800 including a device 805 that supports techniques for using channel aware control channel search space in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for using channel aware control channel search space). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving configuration information that indicates a set of candidates for monitoring for a downlink resource allocation in a downlink control channel transmission. The communications manager 820 is capable of, configured to, or operable to support a means for identifying a channel condition associated with two or more portions of a channel between the UE and a network entity, each of the two or more portions of the channel associated with a different candidate of the set of candidates. The communications manager 820 is capable of, configured to, or operable to support a means for selecting a subset of candidates from the set of candidates to monitor for the downlink resource allocation based on the channel condition associated with each candidate of the subset of candidates. The communications manager 820 is capable of, configured to, or operable to support a means for monitoring the subset of candidates for the downlink resource allocation.

By including or configuring the communications manager 820 in accordance with examples as described herein, the device 805 may support techniques for selection of control channel resources for monitoring for DCI based on channel conditions, which may enhance channel capacity, reduce a quantity of resources to be processed, reduce power consumption, reduce latency, or any combinations thereof.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for using channel aware control channel search space as described herein, or the at least one processor 840 and the at least one memory 830 may be otherwise configured to, individually or collectively, perform or support such operations.

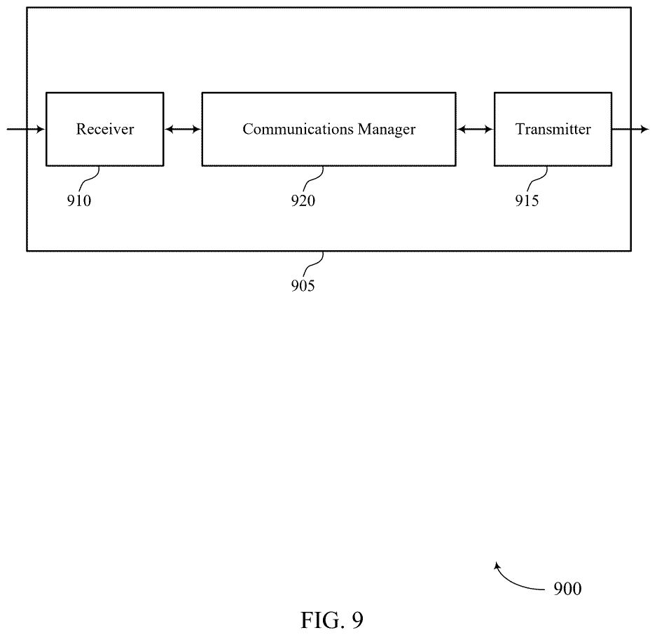

FIG. 9 shows a block diagram 900 of a device 905 that supports techniques for using channel aware control channel search space in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for using channel aware control channel search space as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, to a UE, configuration information that indicates a set of candidates for monitoring at the UE for a downlink resource allocation in a downlink control channel transmission, and an indication that the UE is to select a subset of candidates from the set of candidates to monitor for the downlink resource allocation based on a channel condition of a portion of a channel between the UE and the network entity associated with each candidate of the subset of candidates. The communications manager 920 is capable of, configured to, or operable to support a means for identifying the channel condition associated with two or more portions of the channel between the UE and the network entity, each of the two or more portions of the channel associated with a different candidate of the set of candidates. The communications manager 920 is capable of, configured to, or operable to support a means for selecting, based on the identified channel conditions, a first candidate of the subset of candidates for transmission of first control information that indicates the downlink resource allocation. The communications manager 920 is capable of, configured to, or operable to support a means for outputting the first control information for transmission to the UE.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for selection of control channel resources for transmission of DCI based on channel conditions, which may enhance channel capacity, reduce a quantity of resources to be processed, reduce power consumption, reduce latency, or any combinations thereof.

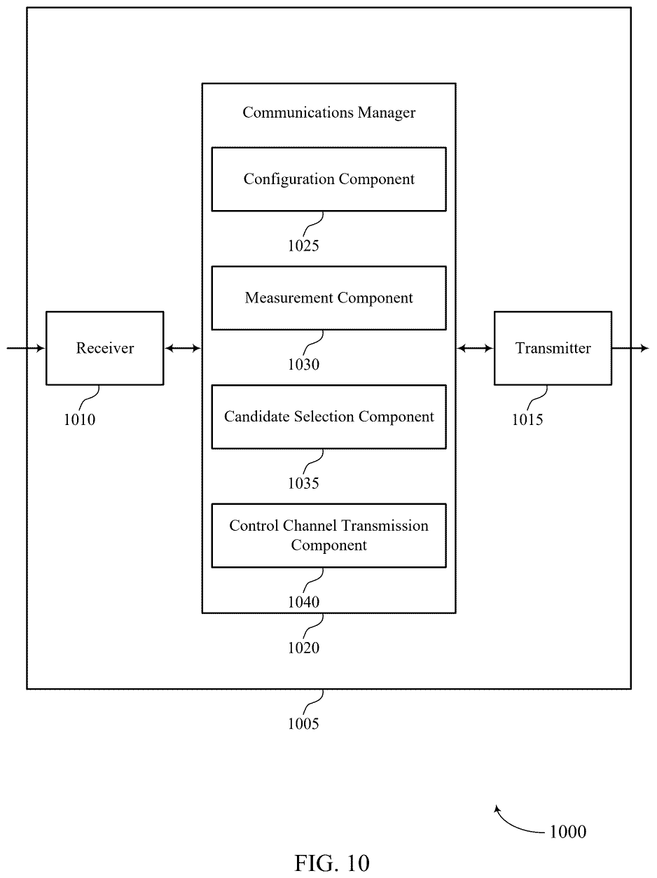

FIG. 10 shows a block diagram 1000 of a device 1005 that supports techniques for using channel aware control channel search space in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for using channel aware control channel search space as described herein. For example, the communications manager 1020 may include a configuration component 1025, a measurement component 1030, a candidate selection component 1035, a control channel transmission component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration component 1025 is capable of, configured to, or operable to support a means for outputting, to a UE, configuration information that indicates a set of candidates for monitoring at the UE for a downlink resource allocation in a downlink control channel transmission, and an indication that the UE is to select a subset of candidates from the set of candidates to monitor for the downlink resource allocation based on a channel condition of a portion of a channel between the UE and the network entity associated with each candidate of the subset of candidates. The measurement component 1030 is capable of, configured to, or operable to support a means for identifying the channel condition associated with two or more portions of the channel between the UE and the network entity, each of the two or more portions of the channel associated with a different candidate of the set of candidates. The candidate selection component 1035 is capable of, configured to, or operable to support a means for selecting, based on the identified channel conditions, a first candidate of the subset of candidates for transmission of first control information that indicates the downlink resource allocation. The control channel transmission component 1040 is capable of, configured to, or operable to support a means for outputting the first control information for transmission to the UE.

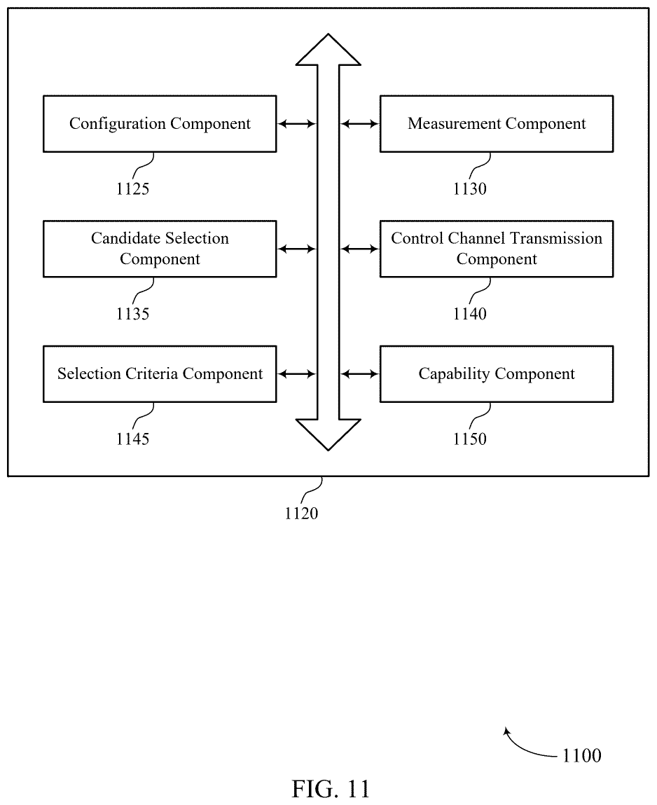

FIG. 11 shows a block diagram 1100 of a communications manager 1120 that supports techniques for using channel aware control channel search space in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for using channel aware control channel search space as described herein. For example, the communications manager 1120 may include a configuration component 1125, a measurement component 1130, a candidate selection component 1135, a control channel transmission component 1140, a selection criteria component 1145, a capability component 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration component 1125 is capable of, configured to, or operable to support a means for outputting, to a UE, configuration information that indicates a set of candidates for monitoring at the UE for a downlink resource allocation in a downlink control channel transmission, and an indication that the UE is to select a subset of candidates from the set of candidates to monitor for the downlink resource allocation based on a channel condition of a portion of a channel between the UE and the network entity associated with each candidate of the subset of candidates. The measurement component 1130 is capable of, configured to, or operable to support a means for identifying the channel condition associated with two or more portions of the channel between the UE and the network entity, each of the two or more portions of the channel associated with a different candidate of the set of candidates. The candidate selection component 1135 is capable of, configured to, or operable to support a means for selecting, based on the identified channel conditions, a first candidate of the subset of candidates for transmission of first control information that indicates the downlink resource allocation. The control channel transmission component 1140 is capable of, configured to, or operable to support a means for outputting the first control information for transmission to the UE.

In some examples, the set of candidates corresponds to a set of UE search space resources that are configured via radio resource control signaling. In some examples, the selection criteria component 1145 is capable of, configured to, or operable to support a means for outputting control signaling that indicates a quantity of candidates of the subset of candidates that are to be selected at the UE based on the identified channel conditions. In some examples, the selection criteria component 1145 is capable of, configured to, or operable to support a means for outputting control signaling that indicates a channel condition threshold for selection of the subset of candidates at the UE, where one or more candidates that meet the channel condition threshold are selected at the UE for the subset of candidates.

In some examples, the capability component 1150 is capable of, configured to, or operable to support a means for obtaining an indication of a capability of the UE to select the subset of candidates based on channel conditions. In some examples, the set of candidates corresponds to all available candidates for monitoring for the downlink resource allocation in the downlink control channel transmission, irrespective of any configured candidates indicated to the UE in control information.

In some examples, the selection criteria component 1145 is capable of, configured to, or operable to support a means for outputting control information that indicates one or more of: a quantity of candidates of the subset of candidates that are to be selected; a difference threshold for measured channel conditions relative to a most favorable measured channel condition, where a candidate that has a measured channel condition within the difference threshold is to be selected for inclusion in the subset of candidates; or operable to support a means for one or more aggregation levels that are to be monitored for the subset of candidates.

In some examples, the first candidate is selected in accordance with an estimated highest channel capacity of the set of candidates based on one or more reference signal measurements associated with the set of candidates. In some examples, the set of candidates corresponds to a set of configured candidates indicated to the UE in control information, and the configuration information indicates that each candidate of the subset of candidates is to be selected at the UE from the set of configured candidates based on a corresponding channel condition that meets a selection criteria. In some examples, the selection criteria component 1145 is capable of, configured to, or operable to support a means for outputting control information that indicates one or more of a quantity of candidates per aggregation level to be included in the subset of candidates, or one or more aggregation levels to be monitored for each candidate of the subset of candidates.

In some examples, the first candidate is selected based on an averaged channel capacity per candidate over all candidate resources of the set of candidates for each aggregation level of two or more available aggregation levels. In some examples, the set of candidates corresponds to a set of configured candidates indicated to the UE in control information, and the configuration information indicates that the UE is to select each candidate of the subset of candidates from the set of configured candidates based on an estimated channel capacity associated with each candidate of the set of candidates.

In some examples, a frequency domain location of the first candidate is selected based on an averaged channel capacity per candidate for a frequency offset from a frequency indicated for the set of configured candidates for each aggregation level associated with the set of configured candidates, and where the frequency offset is selected such that the first candidate remains within a set of frequency resources of the set of configured candidates.

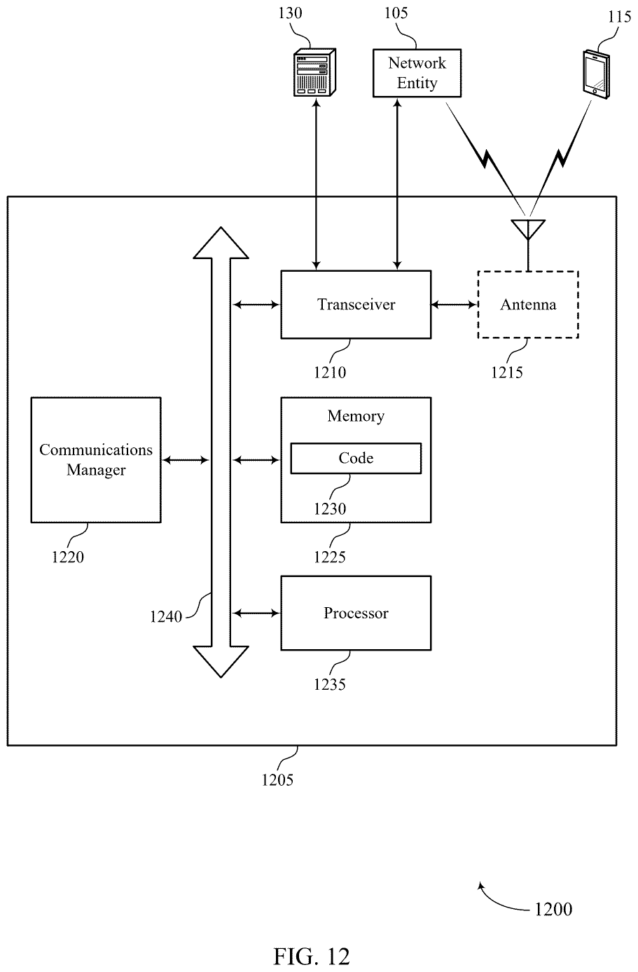

FIG. 12 shows a diagram of a system 1200 including a device 1205 that supports techniques for using channel aware control channel search space in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for using channel aware control channel search space). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting, to a UE, configuration information that indicates a set of candidates for monitoring at the UE for a downlink resource allocation in a downlink control channel transmission, and an indication that the UE is to select a subset of candidates from the set of candidates to monitor for the downlink resource allocation based on a channel condition of a portion of a channel between the UE and the network entity associated with each candidate of the subset of candidates. The communications manager 1220 is capable of, configured to, or operable to support a means for identifying the channel condition associated with two or more portions of the channel between the UE and the network entity, each of the two or more portions of the channel associated with a different candidate of the set of candidates. The communications manager 1220 is capable of, configured to, or operable to support a means for selecting, based on the identified channel conditions, a first candidate of the subset of candidates for transmission of first control information that indicates the downlink resource allocation. The communications manager 1220 is capable of, configured to, or operable to support a means for outputting the first control information for transmission to the UE.

By including or configuring the communications manager 1220 in accordance with examples as described herein, the device 1205 may support techniques for selection of control channel resources for transmission of DCI based on channel conditions, which may enhance channel capacity, reduce a quantity of resources to be processed, reduce power consumption, reduce latency, or any combinations thereof.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for using channel aware control channel search space as described herein, or the at least one processor 1235 and the at least one memory 1225 may be otherwise configured to, individually or collectively, perform or support such operations.

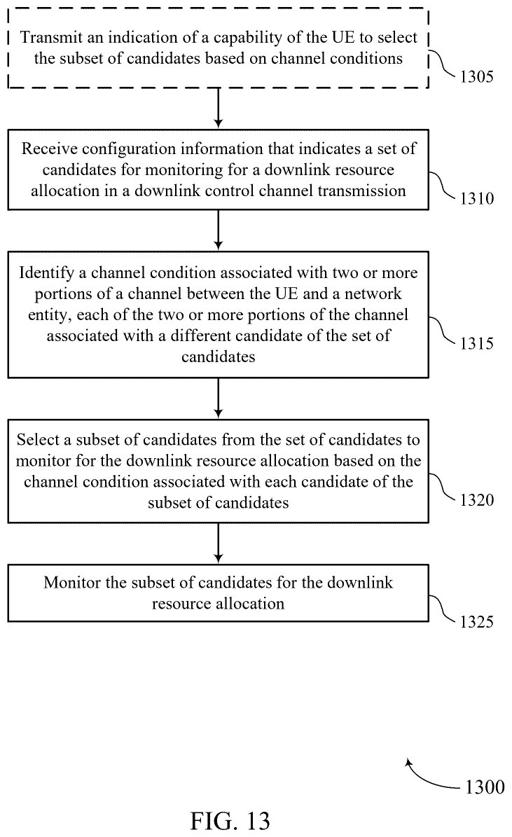

FIG. 13 shows a flowchart illustrating a method 1300 that supports techniques for using channel aware control channel search space in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

Optionally, at 1305, the method may include transmitting an indication of a capability of the UE to select the subset of candidates based on channel conditions. The operations of 1305 may be performed in accordance with examples as disclosed herein. In some examples, aspects of the operations of 1305 may be performed by a capability component 750 as described with reference to FIG. 7.

At 1310, the method may include receiving configuration information that indicates a set of candidates for monitoring for a downlink resource allocation in a downlink control channel transmission. The operations of 1310 may be performed in accordance with examples as disclosed herein. In some examples, aspects of the operations of 1310 may be performed by a configuration component 725 as described with reference to FIG. 7.

At 1315, the method may include identifying a channel condition associated with two or more portions of a channel between the UE and a network entity, each of the two or more portions of the channel associated with a different candidate of the set of candidates. The operations of 1315 may be performed in accordance with examples as disclosed herein. In some examples, aspects of the operations of 1315 may be performed by a measurement component 730 as described with reference to FIG. 7.

At 1320, the method may include selecting a subset of candidates from the set of candidates to monitor for the downlink resource allocation based on the channel condition associated with each candidate of the subset of candidates. The operations of 1320 may be performed in accordance with examples as disclosed herein. In some examples, aspects of the operations of 1320 may be performed by a candidate selection component 735 as described with reference to FIG. 7.

At 1325, the method may include monitoring the subset of candidates for the downlink resource allocation. The operations of 1325 may be performed in accordance with examples as disclosed herein. In some examples, aspects of the operations of 1325 may be performed by a control channel monitoring component 740 as described with reference to FIG. 7.

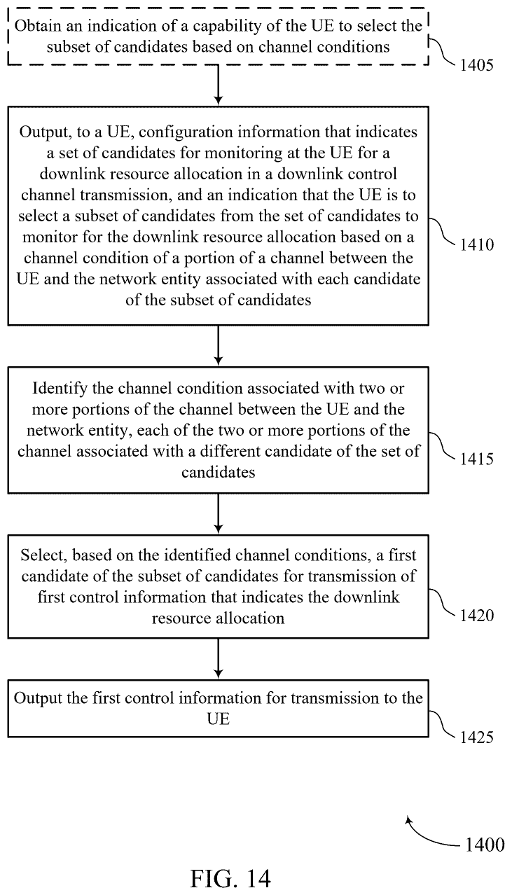

FIG. 14 shows a flowchart illustrating a method 1400 that supports techniques for using channel aware control channel search space in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

Optionally, at 1405, the method may include obtaining an indication of a capability of the UE to select the subset of candidates based on channel conditions. The operations of 1405 may be performed in accordance with examples as disclosed herein. In some examples, aspects of the operations of 1405 may be performed by a capability component 1150 as described with reference to FIG. 11.

At 1410, the method may include outputting, to a UE, configuration information that indicates a set of candidates for monitoring at the UE for a downlink resource allocation in a downlink control channel transmission, and an indication that the UE is to select a subset of candidates from the set of candidates to monitor for the downlink resource allocation based on a channel condition of a portion of a channel between the UE and the network entity associated with each candidate of the subset of candidates. The operations of 1410 may be performed in accordance with examples as disclosed herein. In some examples, aspects of the operations of 1410 may be performed by a configuration component 1125 as described with reference to FIG. 11.

At 1415, the method may include identifying the channel condition associated with two or more portions of the channel between the UE and the network entity, each of the two or more portions of the channel associated with a different candidate of the set of candidates. The operations of 1415 may be performed in accordance with examples as disclosed herein. In some examples, aspects of the operations of 1415 may be performed by a measurement component 1130 as described with reference to FIG. 11.

At 1420, the method may include selecting, based on the identified channel conditions, a first candidate of the subset of candidates for transmission of first control information that indicates the downlink resource allocation. The operations of 1420 may be performed in accordance with examples as disclosed herein. In some examples, aspects of the operations of 1420 may be performed by a candidate selection component 1135 as described with reference to FIG. 11.

At 1425, the method may include outputting the first control information for transmission to the UE. The operations of 1425 may be performed in accordance with examples as disclosed herein. In some examples, aspects of the operations of 1425 may be performed by a control channel transmission component 1140 as described with reference to FIG. 11.

The following provides an overview of aspects of the present disclosure:

Aspect 1: A method for wireless communications at a UE, comprising: receiving configuration information that indicates a set of candidates for monitoring for a downlink resource allocation in a downlink control channel transmission; identifying a channel condition associated with two or more portions of a channel between the UE and a network entity, each of the two or more portions of the channel associated with a different candidate of the set of candidates; selecting a subset of candidates from the set of candidates to monitor for the downlink resource allocation based at least in part on the channel condition associated with each candidate of the subset of candidates; and monitoring the subset of candidates for the downlink resource allocation.

Aspect 2: The method of aspect 1, wherein the set of candidates corresponds to a set of UE search space resources that are configured via radio resource control signaling.

Aspect 3: The method of any of aspects 1 through 2, further comprising: receiving control signaling that indicates a quantity of candidates of the subset of candidates that are to be selected based at least in part on the identified channel conditions.

Aspect 4: The method of any of aspects 1 through 3, further comprising: receiving control signaling that indicates a channel condition threshold for selection of the subset of candidates, wherein one or more candidates that meet the channel condition threshold are selected for the subset of candidates.

Aspect 5: The method of any of aspects 1 through 4, further comprising: transmitting an indication of a capability of the UE to select the subset of candidates based at least in part on channel conditions.

Aspect 6: The method of any of aspects 1 through 5, wherein the set of candidates corresponds to all available candidates for monitoring for the downlink resource allocation in the downlink control channel transmission, irrespective of any configured candidates indicated to the UE in control information.

Aspect 7: The method of aspect 6, further comprising: receiving control information that indicates one or more of: a quantity of candidates of the subset of candidates that are to be selected, a difference threshold for measured channel conditions relative to a most favorable measured channel condition, wherein a candidate that has a measured channel condition within the difference threshold is selected for inclusion in the subset of candidates, or one or more aggregation levels that are to be monitored for the subset of candidates.

Aspect 8: The method of any of aspects 6 through 7, wherein the subset of candidates correspond to frequency domain resources with a highest channel capacity based at least in part on one or more reference signal measurements associated with the set of candidates.

Aspect 9: The method of any of aspects 1 through 5, wherein the set of candidates corresponds to a set of configured candidates indicated to the UE in control information, and each candidate of the subset of candidates is selected from the set of configured candidates based at least in part on a corresponding channel condition that meets a selection criteria.

Aspect 10: The method of aspect 9, further comprising: receiving control information that indicates one or more of a quantity of candidates per aggregation level to be included in the subset of candidates, or one or more aggregation levels to be monitored for each candidate of the subset of candidates.

Aspect 11: The method of any of aspects 9 through 10, wherein the subset of candidates are selected based at least in part on an averaged channel capacity per candidate over all candidate resources of the set of candidates for each aggregation level of two or more available aggregation levels.

Aspect 12: The method of any of aspects 1 through 5, wherein the set of candidates corresponds to a set of configured candidates indicated to the UE in control information, and each candidate of the subset of candidates is selected from the set of configured candidates based at least in part on an estimated channel capacity associated with each candidate of the set of candidates, wherein the estimated channel capacity is based at least in part on an associated channel condition.

Aspect 13: The method of aspect 12, wherein a frequency domain location of each candidate of the subset of candidates is selected based at least in part on an averaged channel capacity per candidate for a frequency offset from a frequency indicated for the set of configured candidates for each aggregation level associated with the set of configured candidates, and wherein the frequency offset is selected such that each candidate of the subset of candidates remains within a set of frequency resources of the set of configured candidates.

Aspect 14: A method for wireless communications at a network entity, comprising: outputting, to a UE, configuration information that indicates a set of candidates for monitoring at the UE for a downlink resource allocation in a downlink control channel transmission, and an indication that the UE is to select a subset of candidates from the set of candidates to monitor for the downlink resource allocation based at least in part on a channel condition of a portion of a channel between the UE and the network entity associated with each candidate of the subset of candidates; identifying the channel condition associated with two or more portions of the channel between the UE and the network entity, each of the two or more portions of the channel associated with a different candidate of the set of candidates; selecting, based at least in part on the identified channel conditions, a first candidate of the subset of candidates for transmission of first control information that indicates the downlink resource allocation; and outputting the first control information for transmission to the UE.

Aspect 15: The method of aspect 14, wherein the set of candidates corresponds to a set of UE search space resources that are configured via radio resource control signaling.

Aspect 16: The method of any of aspects 14 through 15, further comprising: outputting control signaling that indicates a quantity of candidates of the subset of candidates that are to be selected at the UE based at least in part on the identified channel conditions.

Aspect 17: The method of any of aspects 14 through 16, further comprising: outputting control signaling that indicates a channel condition threshold for selection of the subset of candidates at the UE, wherein one or more candidates that meet the channel condition threshold are selected at the UE for the subset of candidates.

Aspect 18: The method of any of aspects 14 through 17, further comprising: obtaining an indication of a capability of the UE to select the subset of candidates based at least in part on channel conditions.

Aspect 19: The method of any of aspects 14 through 18, wherein the set of candidates corresponds to all available candidates for monitoring for the downlink resource allocation in the downlink control channel transmission, irrespective of any configured candidates indicated to the UE in control information.

Aspect 20: The method of aspect 19, further comprising: outputting control information that indicates one or more of: a quantity of candidates of the subset of candidates that are to be selected, a difference threshold for measured channel conditions relative to a most favorable measured channel condition, wherein a candidate that has a measured channel condition within the difference threshold is to be selected for inclusion in the subset of candidates, or one or more aggregation levels that are to be monitored for the subset of candidates.

Aspect 21: The method of any of aspects 19 through 20, wherein the first candidate is selected in accordance with an estimated highest channel capacity of the set of candidates based at least in part on one or more reference signal measurements associated with the set of candidates.

Aspect 22: The method of any of aspects 14 through 18, wherein the set of candidates corresponds to a set of configured candidates indicated to the UE in control information, and the configuration information indicates that each candidate of the subset of candidates is to be selected at the UE from the set of configured candidates based at least in part on a corresponding channel condition that meets a selection criteria.

Aspect 23: The method of aspect 22, further comprising: outputting control information that indicates one or more of a quantity of candidates per aggregation level to be included in the subset of candidates, or one or more aggregation levels to be monitored for each candidate of the subset of candidates.

Aspect 24: The method of any of aspects 22 through 23, wherein the first candidate is selected based at least in part on an averaged channel capacity per candidate over all candidate resources of the set of candidates for each aggregation level of two or more available aggregation levels.

Aspect 25: The method of any of aspects 14 through 18, wherein the set of candidates corresponds to a set of configured candidates indicated to the UE in control information, and the configuration information indicates that the UE is to select each candidate of the subset of candidates from the set of configured candidates based at least in part on an estimated channel capacity associated with each candidate of the set of candidates.

Aspect 26: The method of aspect 25, wherein a frequency domain location of the first candidate is selected based at least in part on an averaged channel capacity per candidate for a frequency offset from a frequency indicated for the set of configured candidates for each aggregation level associated with the set of configured candidates, and wherein the frequency offset is selected such that the first candidate remains within a set of frequency resources of the set of configured candidates.

Aspect 27: A UE for wireless communications, comprising one or more memories storing processor-executable code, and one or more processors coupled with the one or more memories and individually or collectively operable to execute the code to cause the UE to perform a method of any of aspects 1 through 13.

Aspect 28: A UE for wireless communications, comprising at least one means for performing a method of any of aspects 1 through 13.

Aspect 29: A non-transitory computer-readable medium storing code for wireless communications, the code comprising instructions executable by one or more processors to perform a method of any of aspects 1 through 13.

Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.

Aspect 31: A network entity for wireless communications, comprising at least one means for performing a method of any of aspects 14 through 26.

Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information that indicates a set of candidates for monitoring for a downlink resource allocation in a downlink control channel transmission;
identify a channel condition associated with two or more portions of a channel between the UE and a network entity, each of the two or more portions of the channel associated with a different candidate of the set of candidates;
select a subset of candidates from the set of candidates to monitor for the downlink resource allocation based at least in part on the channel condition associated with each candidate of the subset of candidates; and
monitor the subset of candidates for the downlink resource allocation.

2. The UE of claim 1, wherein the set of candidates corresponds to a set of UE search space resources that are configured via radio resource control signaling.

3. The UE of claim 1, wherein the one or more processors are individually or collectively further operable to execute the code to cause the UE to:
receive control signaling that indicates a quantity of candidates of the subset of candidates that are to be selected based at least in part on the identified channel conditions.

4. The UE of claim 1, wherein the one or more processors are individually or collectively further operable to execute the code to cause the UE to:
receive control signaling that indicates a channel condition threshold for selection of the subset of candidates, wherein one or more candidates that meet the channel condition threshold are selected for the subset of candidates.

5. The UE of claim 1, wherein the one or more processors are individually or collectively further operable to execute the code to cause the UE to:
transmit an indication of a capability of the UE to select the subset of candidates based at least in part on channel conditions.

6. The UE of claim 1, wherein the set of candidates corresponds to all available candidates for monitoring for the downlink resource allocation in the downlink control channel transmission, irrespective of any configured candidates indicated to the UE in control information.

7. The UE of claim 6, wherein the one or more processors are individually or collectively further operable to execute the code to cause the UE to:
receive control information that indicates one or more of:
a quantity of candidates of the subset of candidates that be to be selected,
a difference threshold for measure channel conditions relative to a most favorable measured channel condition, wherein a candidate that has a measured channel condition within the difference threshold is selected for inclusion in the subset of candidates, or
one or more aggregation levels that be to be monitored for the subset of candidates.

8. The UE of claim 6, wherein the subset of candidates correspond to frequency domain resources with a highest channel capacity based at least in part on one or more reference signal measurements associated with the set of candidates.

9. The UE of claim 1, wherein the set of candidates corresponds to a set of configured candidates indicated to the UE in control information, and each candidate of the subset of candidates is selected from the set of configured candidates based at least in part on a corresponding channel condition that meets a selection criteria.

10. The UE of claim 9, wherein the one or more processors are individually or collectively further operable to execute the code to cause the UE to:
receive control information that indicates one or more of a quantity of candidates per aggregation level to be included in the subset of candidates, or one or more aggregation levels to be monitored for each candidate of the subset of candidates.

11. The UE of claim 9, wherein the subset of candidates are selected based at least in part on an averaged channel capacity per candidate over all candidate resources of the set of candidates for each aggregation level of two or more available aggregation levels.

12. The UE of claim 1, wherein the set of candidates corresponds to a set of configured candidates indicated to the UE in control information, and each candidate of the subset of candidates is selected from the set of configured candidates based at least in part on an estimated channel capacity associated with each candidate of the set of candidates, wherein the estimated channel capacity is based at least in part on an associated channel condition.

13. The UE of claim 12, wherein a frequency domain location of each candidate of the subset of candidates is selected based at least in part on an averaged channel capacity per candidate for a frequency offset from a frequency indicated for the set of configured candidates for each aggregation level associated with the set of configured candidates, and wherein the frequency offset is selected such that each candidate of the subset of candidates remains within a set of frequency resources of the set of configured candidates.

14. A network entity, comprising:
one or more memories storing processor-executable code; and
one or more processors coupled with the one or more memories and individually or collectively operable to execute the code to cause the network entity to:
output, to a user equipment (UE), configuration information that indicates a set of candidates for monitoring at the UE for a downlink resource allocation in a downlink control channel transmission, and an indication that the UE is to select a subset of candidates from the set of candidates to monitor for the downlink resource allocation based at least in part on a channel condition of a portion of a channel between the UE and the network entity associated with each candidate of the subset of candidates;
identify the channel condition associated with two or more portions of the channel between the UE and the network entity, each of the two or more portions of the channel associated with a different candidate of the set of candidates;
select, based at least in part on the identified channel conditions, a first candidate of the subset of candidates for transmission of first control information that indicates the downlink resource allocation; and
output the first control information for transmission to the UE.

15. The network entity of claim 14, wherein the set of candidates corresponds to a set of UE search space resources that are configured via radio resource control signaling.

16. The network entity of claim 14, wherein the one or more processors are individually or collectively further operable to execute the code to cause the network entity to:
output control signaling that indicates a quantity of candidates of the subset of candidates that are to be selected at the UE based at least in part on the identified channel conditions.

17. The network entity of claim 14, wherein the one or more processors are individually or collectively further operable to execute the code to cause the network entity to:
output control signaling that indicates a channel condition threshold for selection of the subset of candidates at the UE, wherein one or more candidates that meet the channel condition threshold are selected at the UE for the subset of candidates.

18. The network entity of claim 14, wherein the one or more processors are individually or collectively further operable to execute the code to cause the network entity to:
obtain an indication of a capability of the UE to select the subset of candidates based at least in part on channel conditions.

19. The network entity of claim 14, wherein the set of candidates corresponds to all available candidates for monitoring for the downlink resource allocation in the downlink control channel transmission, irrespective of any configured candidates indicated to the UE in control information.

20. The network entity of claim 14, wherein the set of candidates corresponds to a set of configured candidates indicated to the UE in control information, and the configuration information indicates that each candidate of the subset of candidates is to be selected at the UE from the set of configured candidates based at least in part on a corresponding channel condition that meets a selection criteria.

21. The network entity of claim 14, wherein the set of candidates corresponds to a set of configured candidates indicated to the UE in control information, and the configuration information indicates that the UE is to select each candidate of the subset of candidates from the set of configured candidates based at least in part on an estimated channel capacity associated with each candidate of the set of candidates.

22. A method for wireless communications at a user equipment (UE), comprising:
receiving configuration information that indicates a set of candidates for monitoring for a downlink resource allocation in a downlink control channel transmission;
identifying a channel condition associated with two or more portions of a channel between the UE and a network entity, each of the two or more portions of the channel associated with a different candidate of the set of candidates;
selecting a subset of candidates from the set of candidates to monitor for the downlink resource allocation based at least in part on the channel condition associated with each candidate of the subset of candidates; and
monitoring the subset of candidates for the downlink resource allocation.

23. The method of claim 22, further comprising:
receiving control signaling that indicates a quantity of candidates of the subset of candidates that are to be selected based at least in part on the identified channel conditions.

24. The method of claim 22, further comprising:
receiving control signaling that indicates a channel condition threshold for selection of the subset of candidates, wherein one or more candidates that meet the channel condition threshold are selected for the subset of candidates.

25. The method of claim 22, wherein the set of candidates corresponds to all available candidates for monitoring for the downlink resource allocation in the downlink control channel transmission, irrespective of any configured candidates indicated to the UE in control information.

26. The method of claim 22, wherein the set of candidates corresponds to a set of configured candidates indicated to the UE in control information, and each candidate of the subset of candidates is selected from the set of configured candidates based at least in part on a corresponding channel condition that meets a selection criteria.

27. The method of claim 22, wherein the set of candidates corresponds to a set of configured candidates indicated to the UE in control information, and each candidate of the subset of candidates is selected from the set of configured candidates based at least in part on an estimated channel capacity associated with each candidate of the set of candidates, wherein the estimated channel capacity is based at least in part on an associated channel condition.

28. A method for wireless communications at a network entity, comprising:
outputting, to a user equipment (UE), configuration information that indicates a set of candidates for monitoring at the UE for a downlink resource allocation in a downlink control channel transmission, and an indication that the UE is to select a subset of candidates from the set of candidates to monitor for the downlink resource allocation based at least in part on a channel condition of a portion of a channel between the UE and the network entity associated with each candidate of the subset of candidates;
identifying the channel condition associated with two or more portions of the channel between the UE and the network entity, each of the two or more portions of the channel associated with a different candidate of the set of candidates;
selecting, based at least in part on the identified channel conditions, a first candidate of the subset of candidates for transmission of first control information that indicates the downlink resource allocation; and
outputting the first control information for transmission to the UE.

29. The method of claim 28, further comprising:
outputting control signaling that indicates a channel condition threshold for selection of the subset of candidates at the UE, wherein one or more candidates that meet the channel condition threshold are selected at the UE for the subset of candidates.

30. The method of claim 28, wherein the set of candidates corresponds to a set of configured candidates indicated to the UE in control information, and the configuration information indicates that the UE is to select each candidate of the subset of candidates from the set of configured candidates based at least in part on an estimated channel capacity associated with each candidate of the set of candidates.
